(19) United States
(12) Patent Application Publication
(10) Pub. No.: US 2015/0066330 A1
(43) Pub. Date: Mar. 5, 2015

(54) Wireless Communication System For Interfacing Golf And Utility Vehicles With Consumer Electronics Devices

(71) Applicant: Textron Inc., Providence, RI (US)

(72) Inventors: Patrick WARDEN, Grovetown, GA (US); Robert BRADLEY, Augusta, GA (US); Trenton MUNSELL, Martinez, GA (US)

(73) Assignee: TEXTRON INC., Providence, RI (US)

(21) Appl. No.: 14/014,464

(22) Filed: Aug. 30, 2013

(51) Int. Cl. G07C 5/00; G05D 13/00

(52) U.S. Cl. CPC G07C 5/008; G05D 13/00
USPC 701/99

(57) ABSTRACT

A utility vehicle having a plurality of wheels, a motive source providing a motive drive force to at least one of the plurality of wheels, and a vehicle master controller module operably coupled to the motive source. The vehicle master controller module provides a control signal to the motive source. The utility vehicle further includes a consumer electronics device and a wireless module being physically connected to the vehicle master controller module to permit two-way operational communication therebetween. The wireless module is also wirelessly connected to the consumer electronics device to permit two-way operational communication therebetween. The wireless module receives a wireless communication from the consumer electronics device in a first protocol and translates and transmits the wireless communication to the vehicle master controller according to a second protocol.

### FIELD

The present disclosure relates to golf and utility vehicles having a wireless communications system for interfacing the vehicle to a consumer electronics device, such as a tablet or smartphone.

### BACKGROUND

This section provides background information related to the present disclosure which is not necessarily prior art.

Golf and utility vehicles, such as maintenance vehicles, cargo vehicles, and shuttle vehicles, (collectively referred to generally as golf/utility vehicles) typically include one or more electric motors or internal combustion engines to provide motive force and an engine controller or other onboard computer to operably interface and control operation of the motor and/or engine. In some cases, vehicle information may be output to the golf/utility vehicle operator through the use of permanent-mounted, hardwired gauges fixedly coupled thereto. This typically limited the amount of information displayed to the vehicle operator and prevented operator-specific configuration changes available to the vehicle operator and/or owner.

In the event that the engine controller or other onboard computer needed to be modified or otherwise adjusted to vary vehicle parameters, it was typically necessary to employ a complex service interface system, such as a proprietary handheld device that is physically coupled to the golf/utility vehicle via a wired cable or electrical harness.

Accordingly, it should be appreciated that modification and/or adjustment of convention golf/utility vehicle parameters would be limited to only trained-technicians and would thusly limit configurability by the vehicle operator/owner. Moreover, such convention systems further limit the display of information to the vehicle operator/owner, such as vehicle speed, performance, revolutions per minute, temperature, charge state, and the like.

For at least these reasons, there exists a need in the relevant art to provide a communication system for interfacing with golf/utility vehicles that is capable of permitting configuration and/or display of parameters and other information to the vehicle operator/owner. Furthermore, there exists a need in the relevant art to provide a communication system for interfacing with golf/utility vehicles with non-proprietary devices, such as consumer electronics devices. Still further, there exists a need in the relevant art to provide a wireless communication system for interfacing with golf/utility vehicles.

### SUMMARY

This section provides a general summary of the disclosure, and is not a comprehensive disclosure of its full scope or all of its features.

According to some embodiments of the present teachings, a utility vehicle is provided having an advantageous construction. The utility vehicle includes a plurality of wheels, a motive source providing a motive drive force to at least one of the plurality of wheels, and a vehicle master controller module operably coupled to the motive source. The vehicle master controller module provides a control signal to the motive source. The utility vehicle further includes a consumer electronics device and a wireless module being physically connected to the vehicle master controller module to permit two-way operational communication therebetween. The wireless module is also wirelessly connected to the consumer electronics device to permit two-way operational communication therebetween. The wireless module receives a wireless communication from the consumer electronics device in a first protocol and translates and transmits the wireless communication to the vehicle master controller according to a second protocol.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a functional block diagram of a wireless communication system according to some embodiments of the present teachings;

FIG. 2 is a photograph illustrating a wireless module according to some embodiments of the present teachings;

FIG. 3 is an illustration of a virtual dashboard screen of the graphical user interface according to some embodiments of the present teachings;

FIG. 4 is an illustration of a lock condition of the graphical user interface according to some embodiments of the present teachings;

FIG. 5 is an illustration of an error message of the graphical user interface according to some embodiments of the present teachings;

FIG. 6 is an illustration of a vehicle choice screen of the graphical user interface according to some embodiments of the present teachings;

FIG. 7 is an illustration of an administrator login screen of the graphical user interface according to some embodiments of the present teachings;

FIG. 8 is an illustration of an account list screen of the graphical user interface according to some embodiments of the present teachings; and

FIG. 9 is an illustration of a deep data screen of the graphical user interface according to some embodiments of the present teachings.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory, tangible, computer-readable medium. The computer programs may also include stored data. Non-limiting examples of the non-transitory, tangible, computer-readable medium are nonvolatile memory, magnetic storage, and optical storage.

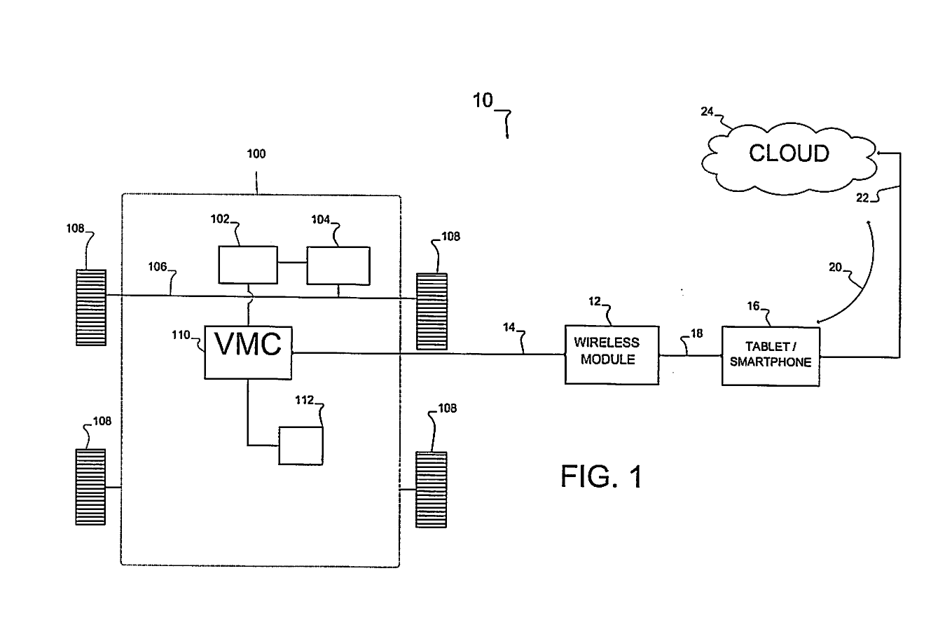

Referring now to FIG. 1, a functional block diagram of an example vehicle system 100 and associated wireless communication system 10 is presented. In some embodiments, the vehicle 100 is a maintenance vehicle, a cargo vehicle, a shuttle vehicle, a golf car, a hunting utility vehicle, a worksite vehicle, a buggy, a lightweight vehicle, or another suitable type of utility or low-speed vehicle that is not designated for use on roadways (hereinafter collectively referred to as utility vehicle 100). Utility vehicle 100 includes a motive source 102, such as one or more electrical motors and/or internal combustion engines that combusts an air/fuel mixture within one or more cylinders. Operation of the motive source 102 outputs torque to a transmission 104. The transmission 104 transfers torque to one or more axles 106 via a conventional torque transfer device to one or more drive wheels 108. It should be appreciated that a motive drive force can be output directly to at least one drive wheel 108 of the vehicle.

In some embodiments according to the principles of the present teachings, wireless communication system 10 can comprise an interface system capable of operably coupling a consumer electronics device to the vehicle communication bus of the utility vehicle 100. To this end, wireless communication system 10 can comprise a wireless module 12. Wireless module 12 can, in some embodiments, operably communicate with a vehicle-based controller, such as a Vehicle Master Controller (VMC) module 110, contained in most utility vehicles via a Controller Area Network (CAN) or bonded communication connection 14. The wireless module 12 can further operably communicate with a consumer electronics device 16 via a wireless communication connection 18. In some embodiments, the consumer electronics device 16 can further communicate via a wireless connection 20, such as via cellular or Wi-Fi connection, or via a wired connection 22, such as an Ethernet connection, to a Cloud-based or other off-site data source 24. It should be understood that wireless module 12 may be referred to as Bluetooth module 12 throughout the present disclosure. However, wireless module 12 is not limited to being a Bluetooth module unless specifically claimed.

Vehicle Master Controller (VMC) 110

As described herein, utility vehicle 100 can comprise Vehicle Master Controller (VMC) module 110. In some embodiments, VMC module 110 is a general purpose controller operably coupled to various systems and sensors of the utility vehicle 100 to obtain, compute, track, control, and/or monitor vehicle performance and operational parameters from a central unit. VMC module 110 can include various input/output (I/O) capabilities and can be operable to execute one or more computer code, such as firmware and OEM and/or user programmed settings, to monitor and/or control motive source 102. By way of non-limiting example, VMC module 110 can be operable to execute code to adjust, modify, control, monitor, and the like, the operation of the vehicle, including throttle performance, brake performance, engine/motor operation, battery performance, power-takeoff, steering, maintenance tracking, and other vehicle functions. In some embodiments, VMC module 110 can include a non-volatile memory feature for maintaining storage of data.

It should be appreciated that VMC module 110 can be operably coupled, such as electrically coupled, to one or more sensors 112. Sensors 112 can be used to track and/or monitor any one of a number of vehicle or other parameters, such as outside temperature, battery charge, vehicle speed, and any other parameter useful during the operation of utility vehicle 100.

During operation, in some embodiments, VMC module 110 can be operable to bond with wireless module 12 (discussed herein) and can include computer-executable code, such as firmware, to implement remote control of the vehicle operating parameters and controls enumerated herein. In some embodiments, VMC module 110 can be used to track and retain maintenance history and permit upload of maintenance software to utility vehicle 100. VMC module 110 can assemble, calculate, monitor, and the like data and output display data to wireless module 12 for display on consumer electronics device 16 (as will be discussed).

Wireless Module 12

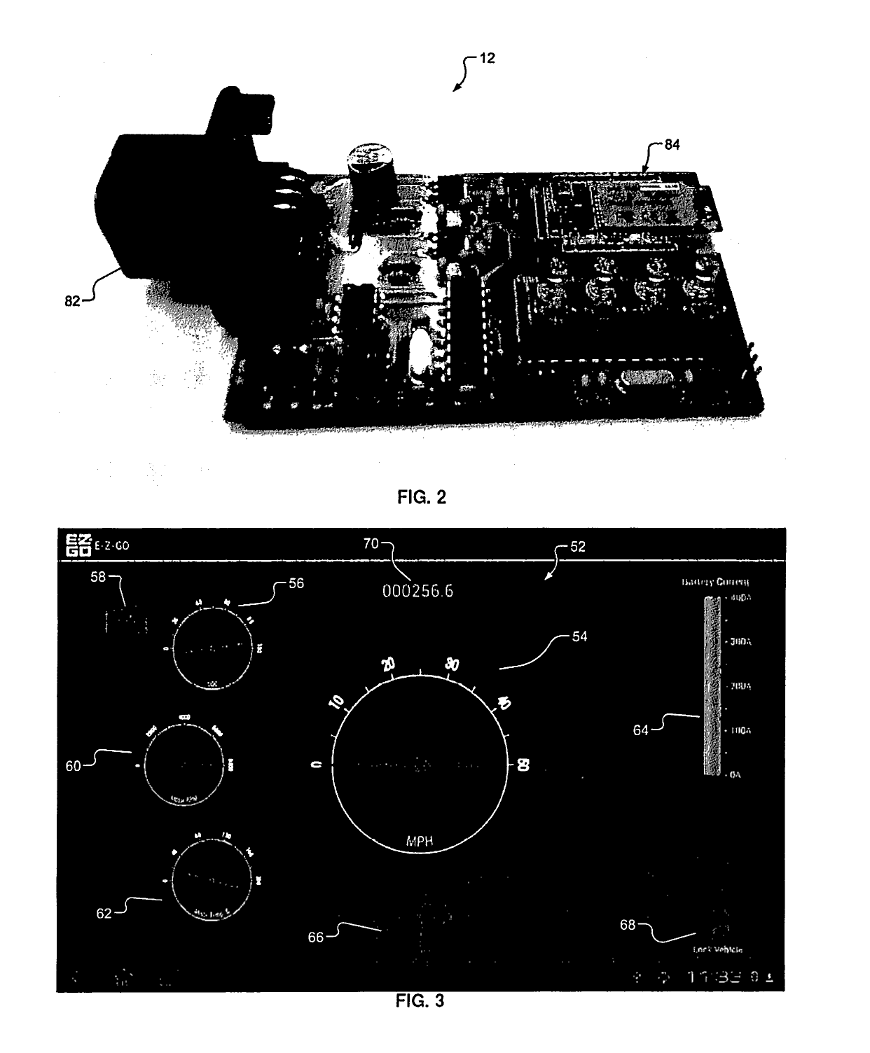

With reference to FIGS. 1 and 2, in some embodiments, wireless module 12 can be operably coupled between consumer electronics device 16 and VMC module 110. In some embodiments, wireless module 12 can be coupled to VMC module 110 via a bonded connection. Specifically, a bonded connection can comprise the act of physically merging wireless module 12 to VMC module 110 to define a two-way communication protocol and exchanging the data necessary to create or confirm a unique vehicle/module link. Once bonded, wireless module 12 and VMC module 110 can function as a single unitary system. In some embodiments, it is anticipated that each wireless module 12 can only bond with a single VMC module 110. Therefore, a currently-bonded wireless module 12 cannot be bonded to another VMC module of another vehicle, thereby preventing wireless module 12 from be taken from one vehicle and used to gain access to another vehicle. For service purposes, however, procedures can be provided that permit unbonding of a wireless module 12 from a particular VMC module 110 to enable replacement of wireless module 12 in the event of a failure.

In some embodiments, it should be appreciated that wireless module 12 can be integrally formed with VMC module 110, rather than as a separate module. In this way, wireless module 12 and VMC module 110 can be physically coupled via a wiring harness or circuit board to provide the required functionality. Accordingly, in some embodiments, new utility vehicles 100 can be manufactured having wireless module 12 integrally and electrically coupled to VMC module 110. Conversely, in some embodiments, wireless module 12 can be provided as an aftermarket device capable of interfacing with an existing VMC module 110 of an existing vehicle. In this way, in some embodiments, wireless module 12 can be operably coupled to an existing port, such as an OBDII port or other maintenance port, to provide a bonded connection with VMC module 110.

As illustrated in FIG. 2, wireless module 12 can comprise at least a connector 82 for physically connecting to VMC module 110. Wireless module 12 can further comprise electrical circuits 84 for executing computer software and/or firmware, including memory features and a central processing unit. Wireless module 12 can comprise software and hardware features capable of achieving the function, methods, and processes described herein.

During operation, in some embodiments, wireless module 12 can be operable to store and permit retrieval of account information (as discussed herein). Moreover, in some embodiments, wireless module 12 can be operable to provide a secure login feature to inhibit unauthorized access to all or a part of the vehicle control and monitored parameters. In some embodiments, wireless module 12 is operable to translate wireless coded information and packets to a two-way communication protocol with VMC module 110. In some embodiments, wireless module 12, and any other coupled devices including the VMC, can be updatable via communication from consumer electronics device 16.

Consumer Electronics Device 16

According to principles of the present teachings, wireless communication system 10 comprises a consumer electronics device 16. In some embodiments, consumer electronics device 16 can comprise a smartphone, such as a telephone having data transfer capabilities; a tablet device, such as a tablet-type, portable computer having a touchscreen or pen-enabled stylus-type interface; or other electronics device commonly owned and/or operated by a consumer. In some embodiments, consumer electronics device 16 can further comprise a graphical user interface (GUI). Consumer electronics device 16 does not typically include interface systems that are commonly owned and/or operated by vehicle technician.

In some embodiments, consumer electronics device 16 can be wirelessly coupled to wireless module 12 via a paired connection 18 to define a two-way communication protocol. Specifically, consumer electronics device 16 can be wirelessly coupled to wireless module 12 via a paired wireless-data exchange employing a wireless protocol, such as Bluetooth, Wi-Fi or near-field communication. Pairing can be described as the act of creating a data link between two wireless devices. It should be understood that the pairing connection does not initially establish a logged-in connection, but in some embodiments can require a password or other authentication procedure to be completed prior to establishing two-way communication for purposes of obtaining vehicle data and/or making changes to vehicle settings.

Once paired, consumer electronics device 16 and wireless module 12 can function as a remote display and/or control device. That is, once paired, consumer electronics device 16 can be used to provide a number of input/output functions relative to VMC module 110 via wireless module 12. In some embodiments, consumer electronics device 16 can be used as a graphical user interface to permit the operator/owner of utility vehicle 100 to display administrator or technical settings of the utility vehicle 100. By way of non-limiting example, consumer electronics device 16 can display maintenance reminders relating to operation of utility vehicle 100, such as in response to detected vehicle conditions. In some embodiments, consumer electronics device 16 can maintain a usage log or other ongoing data log.

Cloud 24

In some embodiments, wireless communication system 10 comprises a cloud computing or off-site data source 24. In some embodiments, cloud 24 can provide computing and/or data from an off-site location via a two-way communication system, such as a wireless communication system including a Wi-Fi communication system or cellular communication system. Cloud 24 can be used for two-way communication such that vehicle data from utility vehicle 100 and data from consumer electronics device 16 can be transmitted and stored thereat and data, such as operational data, maintenance data, and other information from Cloud 24, can be transmitted and stored, accessed, or otherwise used by wireless module 12, VMC module 110, and/or other system of utility vehicle 100. By way of non-limiting example, this data can include closest dealer or service center, troubleshooting information, maintenance schedule, usage data, and the like.

It should also be appreciated that Cloud 24 can be used to transmit other information to consumer electronics device 16, such as advertisements. Advertisements can include targeted advertisements specifically applicable to the vehicle operator/owner, such as upgrade options, service materials, product information relating to uses of utility vehicle 100 (such as golf related advertisements for utility vehicles 100 used on golf courses or hunting-related advertisements for utility vehicles 100 used in off-road or hunting applications).

Still further, Cloud 24 can be used to transmit operational updates, such as operational software, firmware, other software, and the like, to consumer electronics device 16 for update of software executing on consumer electronics device 16, wireless module 12, VMC module 110 and/or other system of utility vehicle 100.

In some embodiments, Cloud 24 can provide operational information, such as local weather information, or can be used to unlock additional features of the utility vehicle 100, such as increased maximum speed limit and the like.

Multiple Accounts

Each consumer electronics device 16 and/or each wireless module 12 can be operable with at least one user account. A user account can include a group of data associated to one user. In some embodiments, a user account can contain information relating to the user's name, password, max allowable driving speed, and any corresponding information. However, in some embodiments, a user account can contain additional drive parameters, including drive time, acceleration profile, and daily allowable operation hours (e.g. can be driven 8 AM to 6 PM).

User Interface

During operation, a user can interface with consumer electronics device 16 and, thus, wireless module 12, VMC module 110 and ultimately with all connected systems of utility vehicle 100 using a graphical user interface (GUI) 50 such as that depicted in FIGS. 3 through 9.

Upon initial log in, which in some embodiments is a secured log in, a ‘Virtual Dashboard’ screen 52 will be displayed as illustrated in FIG. 3. In some embodiments, virtual dashboard screen 52 can comprise a plurality of gauges illustrating performance related and/or operation related parameters traditionally illustrated on road-based vehicles, which are typically not provided on off-road type utility vehicles. By way of non-limiting example, in some embodiments, virtual dashboard screen 52 can comprise a speedometer 54, a state-of-charge gauge 56, a battery alert icon 58, an RPM gauge 60, a motor temperature gauge 62, a battery current gauge 64, a general alert icon 66, a lock vehicle icon 68, a tripometer/odometer 70 or combinations thereof. It should be appreciated that other gauges, icons, and displays can be used and alternative forms of presentation are anticipate (e.g. a digital speedometer, an analog speedometer, and the like).

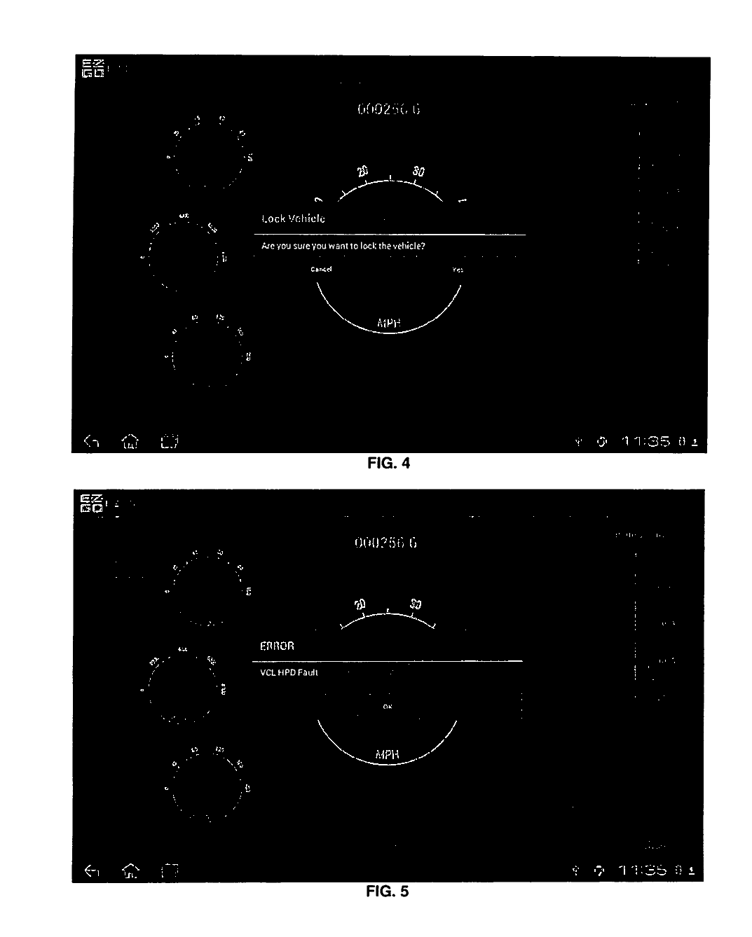

In some embodiments, tripometer/odometer 70 can toggle between being a tripometer and an odometer, such as through tapping on virtual dashboard screen 52 of consumer electronics device 16. In some embodiments, battery current gauge 64 can be illuminated or highlighted to illustrate a current flowing into or out of the batteries of the vehicle. In some embodiments, a fill color can be used (e.g. red) to indicate consumption of power and a different color (e.g. green) can be used when regenerating power. Battery alert icon 58 can be used to indicate battery charging status and/or battery malfunction status. In some embodiments, general alert icon 66 can be used to indicate a vehicle fault. In some embodiments, tapping an alert or gauge can provide additional detail relating to the fault, as illustrated in FIG. 5. This symbol can also be used to prompt the user to maintain the vehicle at the appropriate times. Lock vehicle icon 68 can be used to relock the vehicle when the user is finished, as illustrated in FIG. 4. Locking the vehicle logs out the current user and prevents modification and/or access to wireless module 12, VMC module 110, and/or utility vehicle 100.

Data is streamed from one or more sensors 112 to VMC module 110 to wireless module 12 via bonded connection 14 and ultimately to consumer electronics device 16 via paired connection 18 and is constantly updated on virtual dashboard screen 52.

Multiple Vehicles

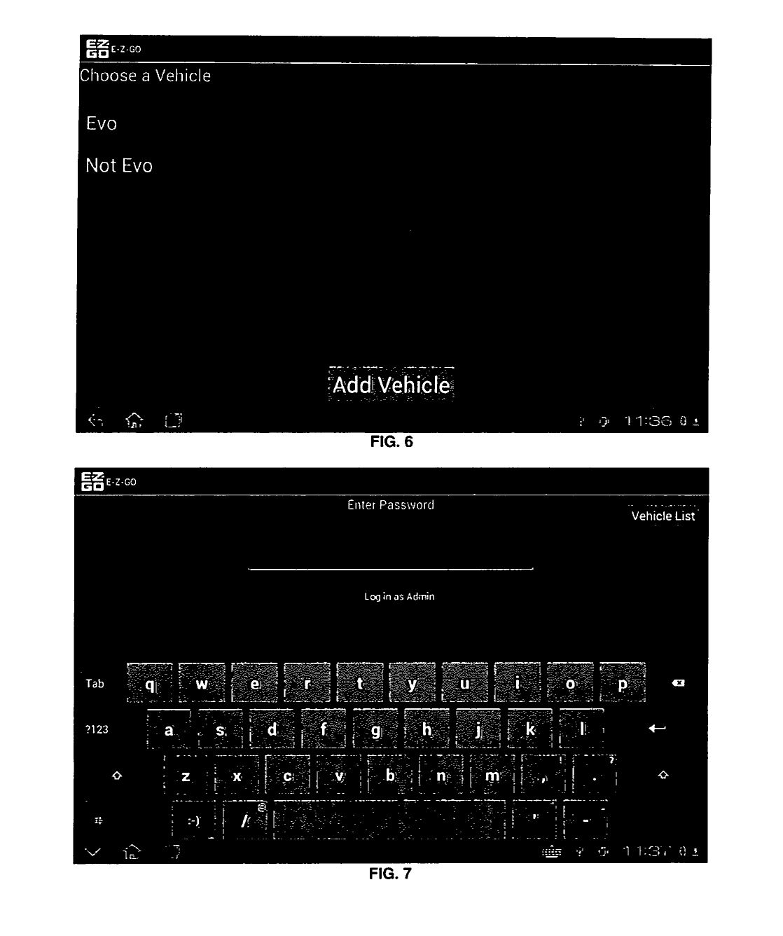

In some embodiments, graphical user interface 50 can be used for multiple vehicles to permit a single consumer electronics device 16 to be used with two or more vehicles (specifically, two or more wireless modules 12). To this end, as illustrated in FIG. 6, upon log in to graphical user interface 50, a user can select one of two or more vehicles. Multiple vehicles are saved in graphical user interface 50 as options for login. The Add Vehicle button 72 at the bottom permits a user to add additional vehicles. In some embodiments, vehicles can be automatically populated in this list upon automatic detection of nearby wireless modules 12. After choosing the vehicle to access, a ‘Password Entry’ screen appears as illustrated in FIG. 7. An acceptable password grants one access to the vehicle with the parameters associated with the specific user account—that is, parameters can vary by user, thereby permitting multiple individuals access to a single vehicles, while each of the users can have varying permissions to vehicle parameters and other settings. In this way, an administrator, for example, can modify a vehicle's speed limit, while a standard user can only access maintenance information. In some embodiments, a log in may be required in order to unlock a vehicle from a locked state to permit vehicle operation. This can insure that only password protected access of the vehicle is permitted. Completion of an operation and/or logging out of a vehicle can return the vehicle to a locked state. This can occur automatically upon a predetermined criterion, such as time, range, and/or the like.

Administrator Option

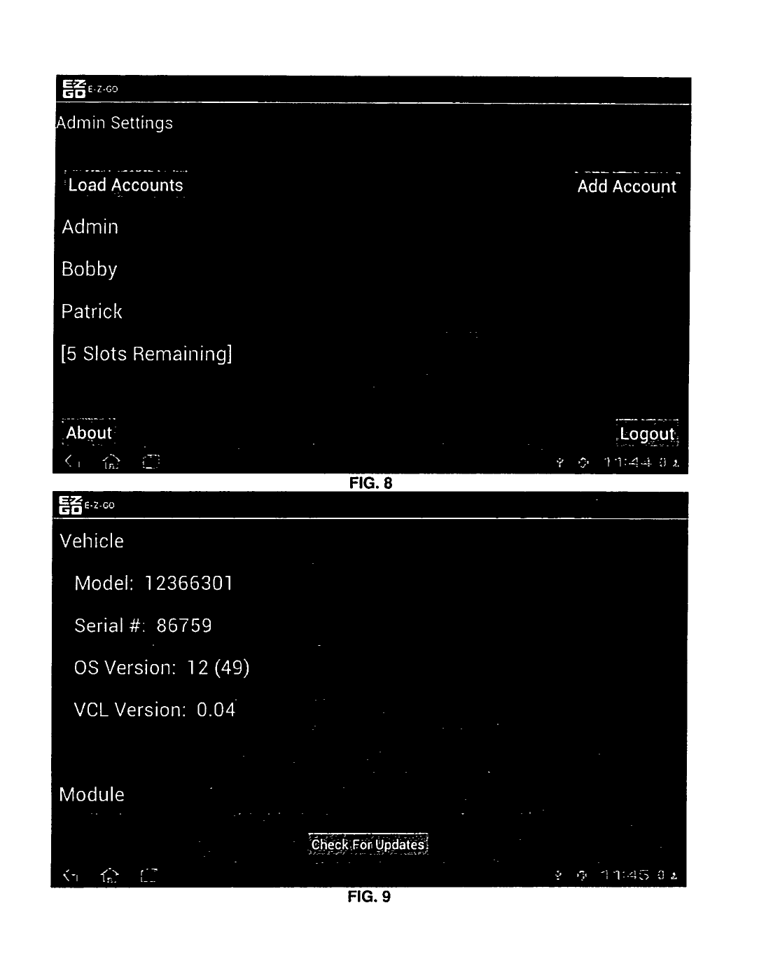

In some embodiments, graphical user interface 50 can be used to log in as an administrator or other state granting additional privileges and/or access to additional parameters. As illustrated in FIG. 8, an administrator login can be used to review, modify, create, and/or delete subordinate accounts, such as standard user accounts.

In some embodiments, each account can have data items associated thereto, such as username (name), password or security pass, maximum speed limits at which the vehicle can be operated, and the like. These data items can be modified, changed, eliminated, or created by an administrator account.

In some embodiments, an administrator account can have access to deep data items, such as model numbers, software and hardware version numbers, and any other information that's access is to be limited, as illustrated in FIG. 9. Moreover, in some embodiments, firmware and/or software updates can be limited to administrator accounts.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A utility vehicle comprising:
a plurality of wheels;
a motive source that provides a motive drive force to at least one of the plurality of wheels;
a vehicle master controller module operably coupled to said motive source, said vehicle master controller module providing a control signal to said motive source;
a consumer electronics device; and
a wireless module being physically connected to said vehicle master controller module to permit two-way operational communication therebetween, said wireless module being wirelessly connect to said consumer electronics device to permit two-way operational communication therebetween, said wireless module being operable to receive a wireless communication from said consumer electronics device in a first protocol and translate and transmit said wireless communication to said vehicle master controller according to a second protocol, said second protocol being different than the first protocol.

2. The utility vehicle according to claim 1, further comprising:
a sensor operably coupled to a system of the utility vehicle, said sensor outputting sensor information to said vehicle master controller module, said vehicle master controller module receiving said sensor information and outputting display data in response thereto, said wireless module operably transmitting said display data to said consumer electronics device and displaying said display data on said consumer electronics device.

3. The utility vehicle according to claim 2 wherein said vehicle master controller module monitors and retains said sensor information.

4. The utility vehicle according to claim 1 wherein said vehicle master controller module executes computer software, said computer software being updateable in response to said consumer electronics device.

5. The utility vehicle according to claim 1 wherein said vehicle master controller module outputs display data to said wireless module, said wireless module operably transmitting said display data to said consumer electronics device and displaying said display data on said consumer electronics device.

6. The utility vehicle according to claim 1 wherein said display data comprise a plurality of vehicle operation parameters.

7. The utility vehicle according to claim 6 wherein said plurality of vehicle operation parameters comprises speed or distance traveled.

8. The utility vehicle according to claim 6 wherein said plurality of vehicle operation parameters comprises parameters relating to operation of said motive source, said parameters including one or more of motive source temperature, motive source RPM, motive source state of charge.

9. The utility vehicle according to claim 1 wherein said wireless module is wirelessly connectable with two or more consumer electronic devices.

10. The utility vehicle according to claim 1 wherein said wireless module is operable to permit selective, secured access to said vehicle master controller module by said consumer electronics device.

11. The utility vehicle according to claim 1 wherein said wireless module is operable to receive a Bluetooth protocol-based communication from said consumer electronics device and translate said Bluetooth protocol-based communication into a Controller Area Network signal transmitted to said vehicle master controller module, said vehicle master controller module being responsive to said Controller Area Network signal from said wireless module.

12. The utility vehicle according to claim 1 wherein said consumer electronics device is operable to display vehicle maintenance reminders in response to detected conditions.

13. The utility vehicle according to claim 1 wherein said consumer electronics device is operable to display a virtual dashboard of gauges indicating real-time vehicle operation.

14. The utility vehicle according to claim 1 wherein said consumer electronics device is operable to provide troubleshooting information relating to performance of the utility vehicle.

15. The utility vehicle according to claim 1, further comprising:
an off-site data source being wirelessly coupled to said consumer electronics device.

16. The utility vehicle according to claim 15 wherein said wireless coupling is a Wi-Fi or cellular coupling.

17. The utility vehicle according to claim 15 wherein said off-site data source is operable to transmit advertisement information to said consumer electronics device.

18. The utility vehicle according to claim 15 wherein said off-site data source is operable to transmit weather information to said consumer electronics device.

19. The utility vehicle according to claim 15 wherein said consumer electronics device is operable to transmit usage information to said off-site data source.

20. The utility vehicle according to claim 1, further comprising:
a cloud computing source wirelessly connect to said consumer electronics device to permit two-way communication therebetween.

21. The utility vehicle according to claim 20 wherein said wireless connection between said consumer electronics device and said cloud computing source is a Wi-Fi or cellular connection.

22. The utility vehicle according to claim 1 wherein said physical connection between said wireless module and said vehicle master controller is a bonded connection.

23. The utility vehicle according to claim 1 wherein said wireless connection between said wireless module and said consumer electronics device is a Bluetooth connection.

24. The utility vehicle according to claim 1 wherein said wireless module is a Bluetooth module being bondedly connected to said vehicle master controller module via said physical connection, said first protocol comprises a Bluetooth protocol-based communication.

25. The utility vehicle according to claim 24 wherein said consumer electronics device is wirelessly connected to said Bluetooth module to permit said two-way operational communication between said consumer electronics device and said Bluetooth module, said consumer electronics device outputting said Bluetooth protocol-based communication to said Bluetooth module in response to user input.
